(19) United States
(12) Patent Application Publication
(10) Pub. No.: US 2013/0045369 A1
(43) Pub. Date: Feb. 21, 2013

(54) CARBON-FIBER-REINFORCED PLASTIC MOLDED OBJECT

(71) Applicants: Shinichi Takemura, Chiyoda-ku (JP); Qingqing Ni, Ueda-shi (JP); Takuo Hashidume, Ueda-shi (JP)

(72) Inventors: Shinichi Takemura, Chiyoda-ku (JP); Qingqing Ni, Ueda-shi (JP); Takuo Hashidume, Ueda-shi (JP)

(73) Assignees: SHINSHU UNIVERSITY, Nagano (JP); JX NIPPON OIL & ENERGY CORPORATION, Tokyo (JP)

(21) Appl. No.: 13/582,483

(22) PCT Filed: Mar. 3, 2011
(86) PCT No.: PCT/JP2011/054993

§ 371 Date: Oct. 26, 2012

(30) Foreign Application Priority Data
Mar. 4, 2010 (JP) 2010-048015
Mar. 4, 2010 (JP) 2010-048017

(51) Int. Cl. B32B 27/08; B32B 17/04; B32B 3/26; B82Y 30/00

(52) U.S. Cl. 428/188; 428/411.1; 428/426; 977/742

(57) ABSTRACT

The present invention provides a CFRP molded object including CFRP layers that are laminated to each other, and a vibration-damping elastic layer disposed between the CFRP layers. The vibration-damping elastic layer includes viscoelastic resin regions that are arranged separately from each other along the x-axis direction, and a high-rigidity resin region including a high-rigidity resin is provided between the viscoelastic resin regions. In the CFRP molded object, the vibration-damping elastic layer including the viscoelastic resin regions and is disposed between the CFRP layers, whereby vibration-damping properties are improved. The viscoelastic resin regions and are arranged separately from each other along the longitudinal direction of the CFRP layers, and the high-rigidity resin region having comparatively higher rigidity is disposed between the viscoelastic resin regions, whereby flexural rigidity along the longitudinal direction of the CFRP layers is secured.

### TECHNICAL FIELD

The present invention relates to a carbon-fiber-reinforced plastic molded object.

### BACKGROUND ART

Carbon-fiber-reinforced plastic molded objects are lighter in weight and have higher rigidity in comparison with metals such as aluminum and iron, and have been drawing attention in recent years as a new material substituted for the metals. Meanwhile, in such carbon-fiber-reinforced plastic molded objects, improvement of vibration-damping properties has been desired. Thus, proposed is a carbon-fiber-reinforced plastic molded object in which a vibration-damping elastic layer including a viscoelastic material such as polyimide is disposed between carbon-fiber-reinforced plastic layers laminated to each other (see Patent Literature 1, for example).

### CITATION LIST

### Patent Literature

[Patent Literature 1] Japanese Patent Application Laid-Open Publication No. 2004-291408

### SUMMARY OF INVENTION

### Technical Problem

Incidentally, there are cases in which such a carbon-fiber-reinforced plastic molded object as described above is applied to an industrial part as part of a supporting member, for example. Accordingly, in the carbon-fiber-reinforced plastic molded object, to secure a certain degree of flexural rigidity is required in addition to improvement of vibration-damping properties. In addition, in the carbon-fiber-reinforced plastic molded object, it is required to improve flexural rigidity while maintaining a certain degree of vibration-damping properties.

Given this situation, an objective of the present invention is to provide a carbon-fiber-reinforced plastic molded object making it possible to improve vibration-damping properties while maintaining flexural rigidity, and the carbon-fiber-reinforced plastic molded object making it possible to improve flexural rigidity while maintaining vibration-damping properties.

### Solution to Problem

To achieve the above-mentioned objective, a carbon-fiber-reinforced plastic molded object according to the present invention is characterized to include first and second carbon-fiber-reinforced plastic layers that are in an elongated shape and laminated to each other, and a vibration-damping elastic layer disposed between the first carbon-fiber-reinforced plastic layer and the second carbon-fiber-reinforced plastic layer, wherein the vibration-damping elastic layer includes a plurality of viscoelastic resin regions including a viscoelastic resin, the viscoelastic resin regions are arranged separately from each other along a longitudinal direction of the first and the second carbon-fiber-reinforced plastic layers, and a high-rigidity resin region including a high-rigidity resin that has higher rigidity than that of the viscoelastic resin is provided between the viscoelastic resin regions adjacent to each other.

In this carbon-fiber-reinforced plastic molded object, the vibration-damping elastic layer having the viscoelastic resin regions is disposed between the first carbon-fiber-reinforced plastic layer and the second carbon-fiber-reinforced plastic layer, whereby vibration-damping properties are improved. In addition, in this carbon-fiber-reinforced plastic molded object, the viscoelastic resin regions are arranged separately from each other along the longitudinal direction of the first and the second carbon-fiber-reinforced plastic layers, and the high-rigidity resin region having comparatively higher rigidity is provided between these viscoelastic resin regions, whereby flexural rigidity along the longitudinal direction of the first and the second carbon-fiber-reinforced plastic layers is secured.

In the carbon-fiber-reinforced plastic molded object according to the present invention, opposing surfaces with the high-rigidity resin region interposed therebetween in the adjacent viscoelastic resin regions are preferred to be approximately parallel to each other. With this configuration, distributions of vibration-damping properties and flexural rigidity become approximately uniform along a direction in which the opposing surfaces with the high-rigidity resin region interposed therebetween extend.

In the carbon-fiber-reinforced plastic molded object according to the present invention, it is preferable that the high-rigidity resin be the same as a resin constituting the first and the second carbon-fiber-reinforced plastic layers, and the high-rigidity resin region be formed integrally with the first and the second carbon-fiber-reinforced plastic layers. With this configuration, when integrally forming the first and the second carbon-fiber-reinforced plastic layers and the vibration-damping elastic layer, it is possible to easily form the high-rigidity resin region with the resin constituting the first and the second carbon-fiber-reinforced plastic layers.

In addition, to achieve the above-mentioned objective, a carbon-fiber-reinforced plastic molded object according to the present invention is characterized to include first and second carbon-fiber-reinforced plastic layers laminated to each other, and a vibration-damping elastic layer disposed between the first carbon-fiber-reinforced plastic layer and the second carbon-fiber-reinforced plastic layer, wherein the vibration-damping elastic layer includes a material containing a viscoelastic resin and a fibrous substance dispersed in the viscoelastic resin, and the fibrous substance has higher rigidity than that of the viscoelastic resin.

In this carbon-fiber-reinforced plastic molded object, between the first carbon-fiber-reinforced plastic layer and the second carbon-fiber-reinforced plastic layer, the vibration-damping elastic layer including the viscoelastic resin and the fibrous substance that is dispersed in the viscoelastic resin and has a relatively higher rigidity is disposed, which makes it possible to improve flexural rigidity while maintaining vibration-damping properties.

In the carbon-fiber-reinforced plastic molded object according to the present invention, it is preferable that the first and the second carbon-fiber-reinforced plastic layers be in an elongated shape, and the vibration-damping elastic layer be divided into a plurality of regions by a plurality of gaps arranged along a longitudinal direction of the first and the second carbon-fiber-reinforced plastic layers. With this configuration, the regions of the vibration-damping elastic layer are arranged separately from each other along the longitudinal direction of the first and the second carbon-fiber-reinforced plastic layers, which makes it possible to improve flexural rigidity along the longitudinal direction of the first and the second carbon-fiber-reinforced plastic layer.

In the carbon-fiber-reinforced plastic molded object according to the present invention, opposing surfaces with the gap interposed therebetween are preferred to be approximately parallel to each other in the adjacent regions. With this configuration, it is possible to make distributions of vibration-damping properties and flexural rigidity approximately uniform along the direction in which the opposing surfaces with the gap interposed therebetween extend.

In the carbon-fiber-reinforced plastic molded object according to the present invention, the fibrous substance is preferred to be at least one out of carbon nanotube, Ketjenblack, short glass fiber, and short carbon fiber. With this configuration, it is possible to preferably improve flexural rigidity using carbon nanotube, Ketjenblack, short glass fiber, and short carbon fiber.

### Advantageous Effects of Invention

According to the present invention, it is possible to provide a carbon-fiber-reinforced plastic molded object making it possible to improve vibration-damping properties while maintaining flexural rigidity, and a carbon-fiber-reinforced plastic molded object making it possible to improve flexural rigidity while maintaining vibration-damping properties.

### BRIEF DESCRIPTION OF DRAWINGS

FIG. 1 is a perspective view of a first embodiment of a carbon-fiber-reinforced plastic molded object according to the present invention.

FIG. 2 is a partial sectional view along a line II-II in FIG. 1.

FIG. 3 is a partial sectional view along a line in FIG. 1.

FIG. 4 is a perspective view of a second embodiment of the carbon-fiber-reinforced plastic molded object according to the present invention.

FIG. 5 is a sectional view along a line V-V in FIG. 4.

FIG. 6 includes perspective views of carbon-fiber-reinforced plastic molded objects according to the comparative examples.

FIG. 7 includes graphs illustrating measurement results of flexural rigidity and vibration-damping properties of the carbon-fiber-reinforced plastic molded objects according to the examples and the comparative examples.

FIG. 8 is a perspective view of a third embodiment of the carbon-fiber-reinforced plastic molded object according to the present invention.

FIG. 9 is a partial sectional view along a line II-II in FIG. 8.

FIG. 10 is a perspective view of a fourth embodiment of the carbon-fiber-reinforced plastic molded object according to the present invention.

FIG. 11 is a partial sectional view along a line IV-IV in FIG. 10.

FIG. 12 is a partial sectional view along a line V-V in FIG. 10.

FIG. 13 includes graphs illustrating measurement results of flexural rigidity and vibration-damping properties of the carbon-fiber-reinforced plastic molded objects according to the examples and the comparative examples.

### DESCRIPTION OF EMBODIMENTS

Preferred embodiments of the present invention will be described hereinafter with reference to the attached drawings. Note that like numerals are given to like or corresponding components in each of the drawings, and duplicate descriptions will be omitted.

### First Embodiment

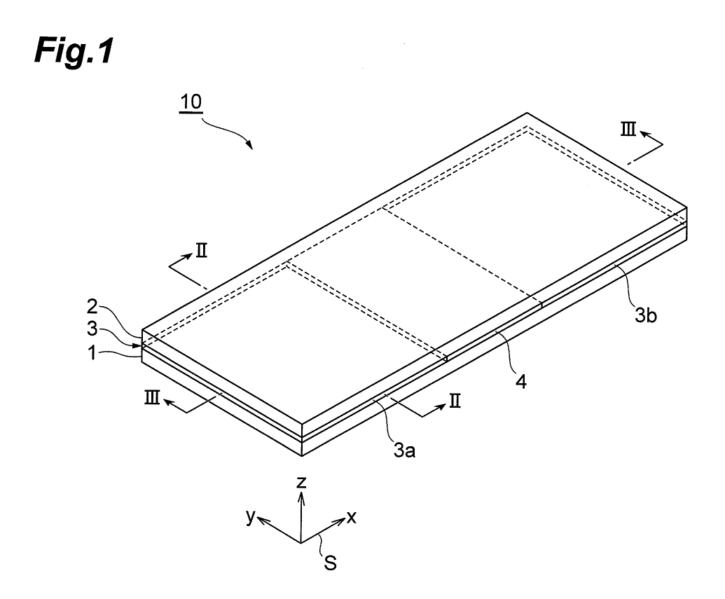

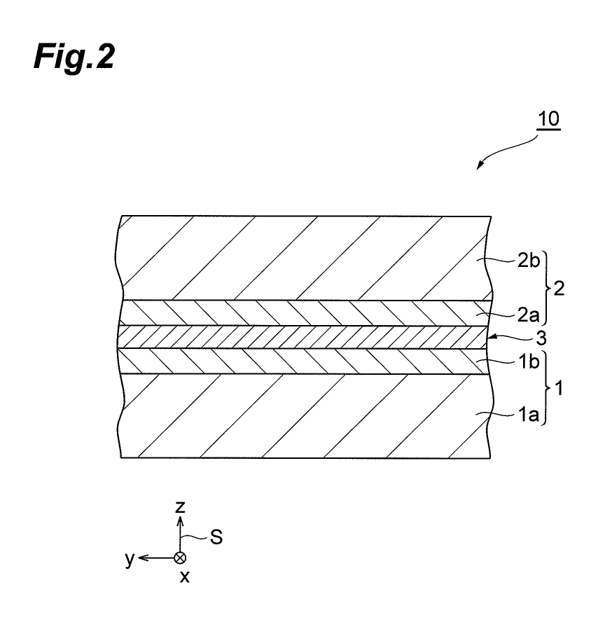

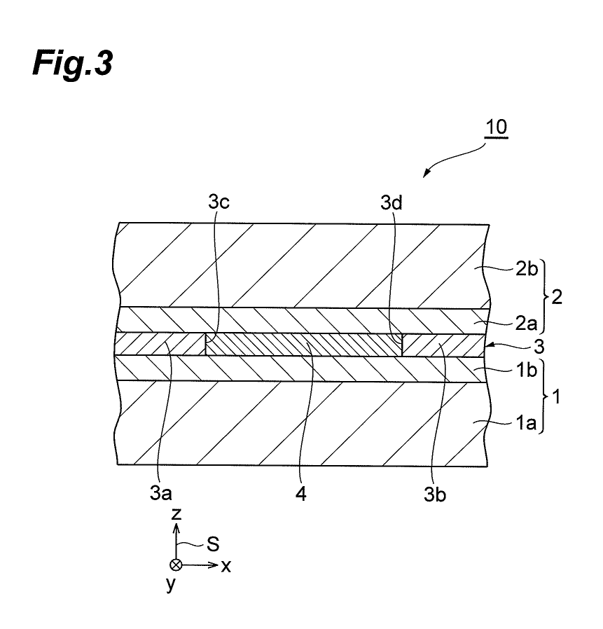

As depicted in FIGS. 1 to 3, a carbon-fiber-reinforced plastic (hereinafter, referred to as “CFPR”) molded object 10 includes a CFRP layer 1 (a first carbon-fiber-reinforced plastic layer) and a CFRP layer 2 (a second carbon-fiber-reinforced layer) that are laminated to each other along the z-axis direction of a rectangular coordinate system S, and a vibration-damping elastic layer 3 disposed between the CFRP layer 1 and the CFRP layer 2. This CFRP molded object 10 can be used for industrial parts such as a robot hand, for example.

The CFRP layers 1 and 2 each are in a shape of an elongated plate extending along the x-axis direction of the rectangular coordinate system S, and include a plurality of carbon fiber layers including carbon fibers and a matrix resin (e.g., epoxy resin) with which the carbon fiber layers are impregnated and cured.

The CFRP layer 1 includes an outer layer 1a and an inner layer 1b that are laminated in this order along the z-axis direction. The outer layer 1a can be configured to include, for example, five carbon fiber layers that are disposed in such a manner that the orientation direction of the carbon fibers becomes 0 degree. In addition, the inner layer 1b can be configured to include, for example, one carbon fiber layer that is disposed in such a manner that the orientation direction of the carbon fibers becomes 90 degrees. Note that the angles herein mean angles with respect to the x-axis direction.

The CFRP layer 2 includes an inner layer 2a and an outer layer 2b that are laminated in this order along the z-axis direction. The inner layer 2a can be configured to include, for example, one carbon fiber layer that is disposed in such a manner that the orientation direction of the carbon fibers becomes 90 degrees. In addition, the outer layer 2b can be configured to include, for example, five carbon fiber layers that are disposed in such a manner that the orientation direction of the carbon fibers becomes 0 degree.

The vibration-damping elastic layer 3 has a viscoelastic resin region 3a and a viscoelastic resin region 3b that are arranged separately from each other along the longitudinal direction (x-axis direction) of the CFRP layers 1 and 2. The viscoelastic resin regions 3a and 3b each include a viscoelastic resin. The viscoelastic resin can be a resin that has lower rigidity than that of a matrix resin constituting the CFRP layers 1 and 2 and is made of viscoelastic material (flexible resin material) such as a rubber and an elastomer. The storage elastic modulus at 25° C. of the viscoelastic material is preferred to be within a range of 0.1 MPa or more and 2500 MPa or less, further preferred to be within a range of 0.1 MPa or more and 250 MPa or less, and still further preferred to be within a range of 0.1 MPa or more and 25 MPa or less. When the storage elastic modulus of the viscoelastic material is equal to or lower than 2500 MPa, sufficient vibration-damping properties can be obtained and, when it is equal to or higher than 0.1 MPa, decrease in rigidity of the CFRP molded object 10 is small, and thus performance required for industrial parts such as a robot hand or a robot arm can be achieved. In addition, as transformation from a carbon fiber prepreg to the CFRP is performed by heat curing, the viscoelastic material is preferred to be stable against the heat generated during the heat curing. Furthermore, the viscoelastic material is preferred to be a material that is excellent in an adhesive property to the matrix resin of the CFRP layers 1 and 2.

In view of the foregoing, the viscoelastic material constituting the viscoelastic resin regions 3a and 3b can be a material that is more flexible than the CFRP, examples of which include a rubber such as a styrene-butadiene rubber (SBR), a chloroprene rubber (CR), an isobutylene-isoprene rubber (IIR), a nitrile-butadiene rubber (NBR), and an ethylene-propylene rubber (EPM, EPDM), a polyester resin, a vinylester resin, a polyurethane resin, and an epoxy resin whose elastic modulus is reduced by adding a rubber, an elastomer, or the like that is a polymer having a flexible chain.

Between the viscoelastic resin region 3a and the viscoelastic resin region 3b, a high-rigidity resin region 4 including a high-rigidity resin (e.g., an epoxy resin) that has higher rigidity than that of the viscoelastic resin is provided. The high-rigidity resin region 4 is disposed between the viscoelastic resin region 3a and the viscoelastic resin region 3b without a gap. Note that in the viscoelastic resin regions 3a and 3b, opposing surfaces 3c and 3d with the high-rigidity resin region 4 interposed therebetween each extend along the y-axis direction of the rectangular coordinate system S, and also are approximately parallel to each other.

This vibration-damping elastic layer 3 can be manufactured, for example, by pouring a solution of the viscoelastic resin into a sheet-shaped mold to dry it, heating and pressing the resulting resin by an hot-pressing apparatus to form a layer, and then cutting off a center portion thereof in the longitudinal direction.

In addition, the CFRP molded object 10 is manufactured, for example, by disposing the vibration-damping elastic layer 3 manufactured as described above between a prepreg laminate for the CFRP layer 1 and a prepreg laminate for the CFRP layer 2, and heating and pressing them to integrally form the CFRP layer 1, the vibration-damping elastic layer 3, and the CFRP layer 2. At this time, the high-rigidity resin region 4 can be formed with the matrix resin constituting the CFRP layers 1 and 2. In this case, the high-rigidity resin region 4 is formed integrally with the CFRP layers 1 and 2.

As described above, in the CFRP molded object 10, the vibration-damping elastic layer 3 having the viscoelastic resin regions 3a and 3b is disposed between the CFRP layer 1 and the CFRP layer 2, whereby vibration-damping properties are improved. In addition, in the CFRP molded object 10, the viscoelastic resin regions 3a and 3b are arranged separately from each other along the x-axis direction, and the high-rigidity resin region 4 having comparatively higher rigidity is provided between these viscoelastic resin regions 3a and 3b, whereby flexural rigidity along the x-axis direction is secured.

In addition, in the CFRP molded object 10, the opposing surfaces 3c and 3d with the high-rigidity resin region 4 interposed therebetween are approximately parallel to each other in the viscoelastic resin regions 3a and 3b, and accordingly distributions of vibration-damping properties and flexural rigidity become approximately uniform along the extending direction (y-axis direction) of these surfaces 3c and 3d.

### Second Embodiment

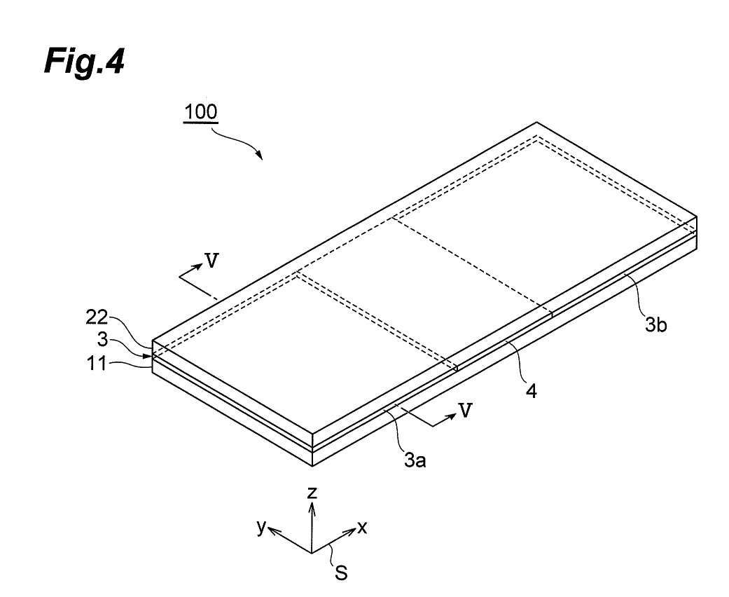

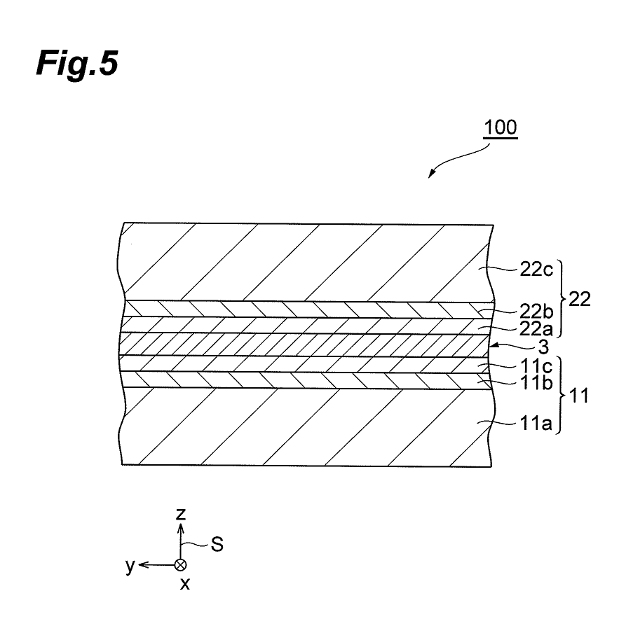

As depicted in FIGS. 4 and 5, a CFRP molded object 100 differs from the CFRP molded object 10 according to the first embodiment in including a CFRP layer 11 (a first carbon-fiber-reinforced plastic layer) in place of the CFRP layer 1, and in including a CFRP layer 22 (a second carbon-fiber-reinforced plastic layer) in place of the CFRP layer 2.

The CFRP layers 11 and 22 each are in a shape of elongated plate extending along the x-axis direction, and include a plurality of carbon fiber layers including carbon fibers and a matrix resin (e.g., an epoxy resin) with which the carbon fiber layers are impregnated and cured.

The CFRP layer 11 includes an outer layer 11a, an intermediate layer 11b, and an inner layer 11c that are laminated in this order along the z-axis direction. The outer layer 11a can be configured to include, for example, four carbon fiber layers that are disposed in such a manner that the orientation direction of the carbon fibers becomes 0 degree. In addition, the intermediate layer 11b can be configured to include, for example, one carbon fiber layer that is disposed in such a manner that the orientation direction of the carbon fibers becomes 90 degrees. Furthermore, the inner layer 11c can be configured to include, for example, one carbon fiber layer that is disposed in such a manner that the orientation direction of the carbon fibers becomes 0 degree. Note that the angles herein mean angles with respect to the x-axis direction.

The CFRP layer 22 includes an inner layer 22a, an intermediate layer 22b, and an outer layer 22c that are laminated in this order along the z-axis direction. The inner layer 22a can be configured to include, for example, one carbon fiber layer that is disposed in such a manner that the orientation direction of the carbon fibers becomes 0 degree. In addition, the intermediate layer 22b can be configured to include, for example, one carbon fiber layer that is disposed in such a manner that the orientation direction of the carbon fibers becomes 90 degrees. Furthermore, the outer layer 22c can be configured to include, for example, four carbon fiber layers that are disposed in such a manner that the orientation direction of the carbon fibers becomes 0 degree.

As described above, also in the CFRP molded object 100, the vibration-damping elastic layer 3 having the viscoelastic resin regions 3a and 3b is disposed between the CFRP layer 11 and the CFRP layer 22, whereby vibration-damping properties are improved. In addition, the viscoelastic resin regions 3a and 3b are arranged separately from each other along the x-axis direction, and the high-rigidity resin region 4 having comparatively higher rigidity is provided between the viscoelastic resin regions 3a and 3b, whereby flexural rigidity along the x-axis direction is secured.

Note that in the CFRP molded object 10 and the CFRP molded object 100 according to the first and the second embodiments described above, the vibration-damping elastic layer 3 is assumed to include two viscoelastic resin regions 3a and 3b, but it is not limited to this, and the vibration-damping elastic layer 3 can be configured to have three or more viscoelastic resin regions that are arranged separately from each other along the x-axis direction.

### Example 1

### (1) Specimens

As examples of the CFRP molded object according to the present invention, a specimen A1 corresponding to the CFRP molded object 10 and a specimen A2 corresponding to the CFRP molded object 100 were prepared as follows.

(1-1) Specimen A1

A first prepreg laminate was obtained by laminating five layers of GRANOC prepreg (GRANOC XN-60 (tensile modulus: 620 GPa, carbon fiber areal weight: 125 g/m², matrix resin content: 32 wt %, thickness per layer: 0.11 mm) manufactured by Nippon Graphite Fiber Corporation, the same applies to the following) in such a manner that the orientation direction of the carbon fibers became 0 degree, and laminating thereon one layer of GRANOC prepreg in such a manner that the orientation direction of the carbon fibers became 90 degrees. In addition, a second prepreg laminate was obtained by disposing one layer of GRANOC prepreg in such a manner that the orientation direction of the carbon fibers became 90 degrees, and laminating thereon five layers of GRANOC prepreg in such a manner that the orientation direction of the carbon fibers became 0 degree. Meanwhile, the vibration-damping elastic layer 3 having a thickness of 0.15 mm was obtained by pouring a solution of polyurethane resin (Diary (MS4510) manufactured by Diaplex Co., Ltd., the same applies to the following) into a sheet-shaped mold to dry it, heating and pressing the resulting resin at 150° C. for one hour by a hot-pressing apparatus to form a layer, and then cutting off a center portion thereof in the longitudinal direction. At this time, the width of the cut portion was 10 mm. Then, the specimen A1 including the CFRP layer 1, the vibration-damping elastic layer 3, and the CFRP layer 2 was obtained by laminating the first prepreg laminate, the vibration-damping elastic layer 3, and the second prepreg laminate in this order, heating and pressing them at 130° C. for one and a half hours, and integrally forming them. Note that an epoxy resin was used as the material for the high-rigidity resin region 4.

(1-2) Specimen A2

A third prepreg laminate was obtained by laminating four layers of GRANOC prepreg in such a manner that the orientation direction of the carbon fibers became 0 degree, laminating thereon one layer of GRANOC prepreg in such a manner that the orientation direction of the carbon fibers became 90 degrees, and further laminating thereof one layer of GRANOC prepreg in such a manner that the orientation direction of the carbon fibers became 0 degree. In addition, a fourth prepreg laminate was obtained by disposing one layer of GRANOC prepreg in such a manner that the orientation direction of the carbon fibers became 0 degree, laminating thereon one layer of GRANOC prepreg in such a manner that the orientation direction of the carbon fibers became 90 degrees, and further laminating thereon four layers of GRANOC prepreg in such a manner that the orientation direction of the carbon fibers became 0 degree. Meanwhile, the vibration-damping elastic layer 3 having a thickness of 0.1 mm was obtained by pouring a solution of the polyurethane resin into the sheet-shaped mold to dry it, heating and pressing the resulting resin at 150° C. for one hour by the hot-pressing apparatus to form a layer, and then cutting off a center portion thereof in the longitudinal direction. At this time, the width of the cut portion was 10 mm. Then, the specimen A2 including the CFRP layer 11, the vibration-damping elastic layer 3, and the CFRP layer 22 was obtained by laminating the third prepreg laminate, the vibration-damping elastic layer 3, and the fourth prepreg laminate in this order, heating and pressing them at 130° C. for one and a half hours, and integrally forming them. Note that an epoxy resin was used as the material for the high-rigidity resin region 4.

### (2) Comparative Examples

As comparative examples for the specimens A1 and A2, a comparative specimen B1 and a comparative specimen B2 described below were prepared.

(2-1) Comparative Specimen B1

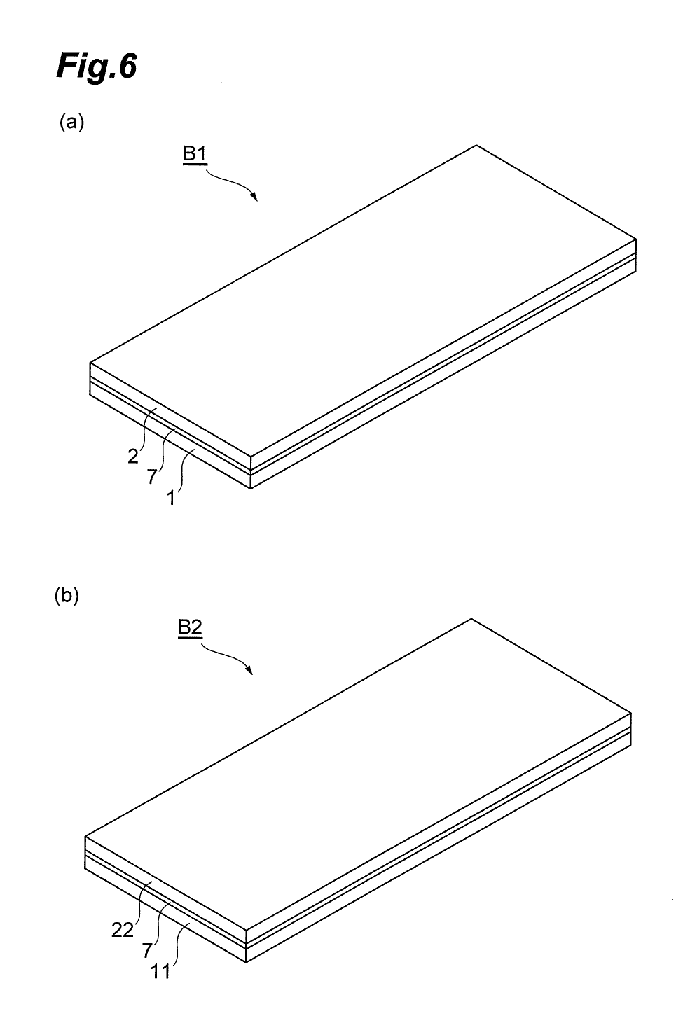

The comparative specimen B1 differs from the specimen A1 in including a vibration-damping elastic layer 7 in place of the vibration-damping elastic layer 3 as depicted in FIG. 6(a). The vibration-damping elastic layer 7 includes a single region having a thickness of 0.1 mm, and the material thereof is a polyurethane resin.

(2-2) Comparative Specimen B2

The comparative specimen B2 differs from the specimen A2 in including a vibration-damping elastic layer 7 in place of the vibration-damping elastic layer 3 as depicted in FIG. 6(b).

All of the specimens A1 and A2 and the comparative specimens B1 and B2 described above have a length of about 45 mm, a width of about 5 mm, a thickness of about 1.4 mm or more and 1.5 mm or less.

### (3) Measurement

By using a dynamics mechanical analysis (DMA) measurement apparatus (ITK-DVA225) manufactured by IT Measurement Control Co., Ltd., in a three-point bending vibration mode along the longitudinal direction, the storage elastic modulus (elastic component)=E′, the loss storage elastic modulus (viscous component)=E″, and the loss tangent=E″/E′=tan δ for each of the specimens A1 and A2 and the comparative specimens B1 and B2 were measured. Herein, the three-point bending vibration mode is a measuring method for measuring viscoelastic behavior by applying vibration to the center portion with both end portions clamped in the longitudinal direction for each specimen.

### (4) Measurement Results

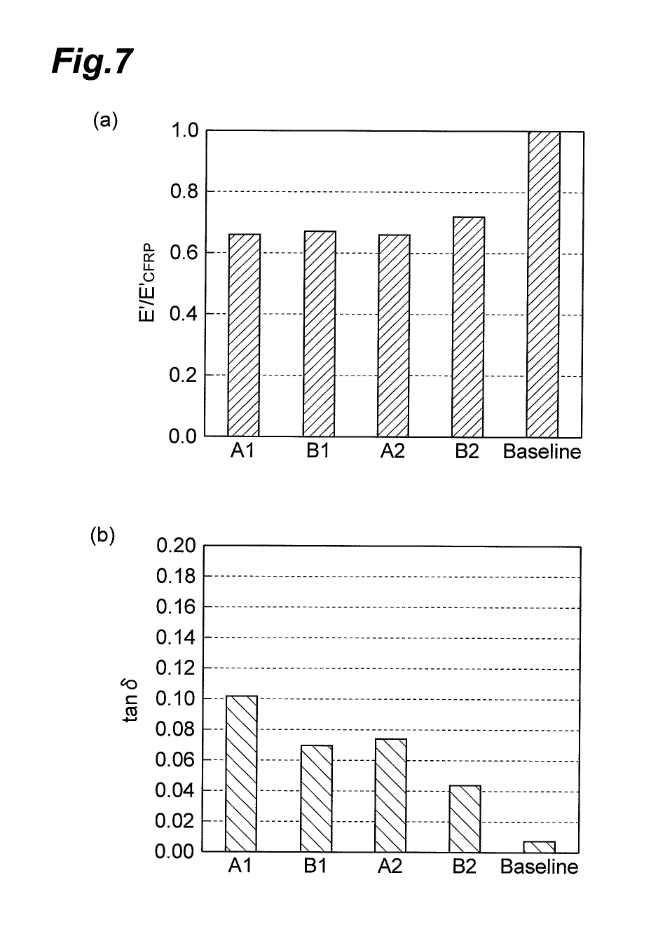

The measurement results are illustrated in FIG. 7. FIG. 7(a) depicts the flexural elastic modulus retention ratio (E′/E′_{CFRP}) of each specimen at 25° C. Herein, E′_{CFRP} is a storage elastic modulus of a CFRP molded object that does not have a vibration-damping elastic layer (including only the CFRP layer 1 and the CFRP layer 2). FIG. 7(b) depicts tan δ of each specimen at 25° C. In FIGS. 7(a) and 7(b), A1 represents a measurement value of the specimen A1, A2 represents a measurement value of the specimen A2, B1 represents a measurement value of the comparative specimen B1, and B2 represents a measurement value of the comparative specimen B2. Note that in these drawings, Baseline represents a measurement value of the CFRP molded object that does not have a vibration-damping elastic layer. Herein, the flexural elastic modulus retention ratio (E′/E′_{CFRP}) is a value as an index of flexural rigidity, and as this value becomes larger, the flexural rigidity becomes higher. The tan δ is a value as an index of vibration-damping properties, and as this value becomes larger, the vibration-damping properties become higher.

As depicted in FIG. 7(b), tan δ of the specimen A1 was 0.102, and tan δ of the comparative specimen B1 was 0.07. In addition, tan δ of the specimen A2 was 0.074, and tan δ of the comparative specimen B2 was 0.044. From these, it was found that vibration-damping properties were improved each in the specimen A1 and the specimen A2 compared to the comparative specimen B1 and the comparative specimen B2.

In addition, as depicted in FIG. 7(a), E′/E′_{CFRP} of the specimen A1 and E′/E′_{CFRP} of the comparative specimen B1 were approximately nearly equal. In addition, E′/E′_{CFRP} of the specimen A2 and E′/E′_{CFRP} of the comparative specimen B2 were approximately nearly equal. From these, it was found that flexural rigidity comparable to that of the comparative specimen B1 and the comparable specimen B2 was maintained each in the specimen A1 and the specimen A2 along the longitudinal direction.

### Third Embodiment

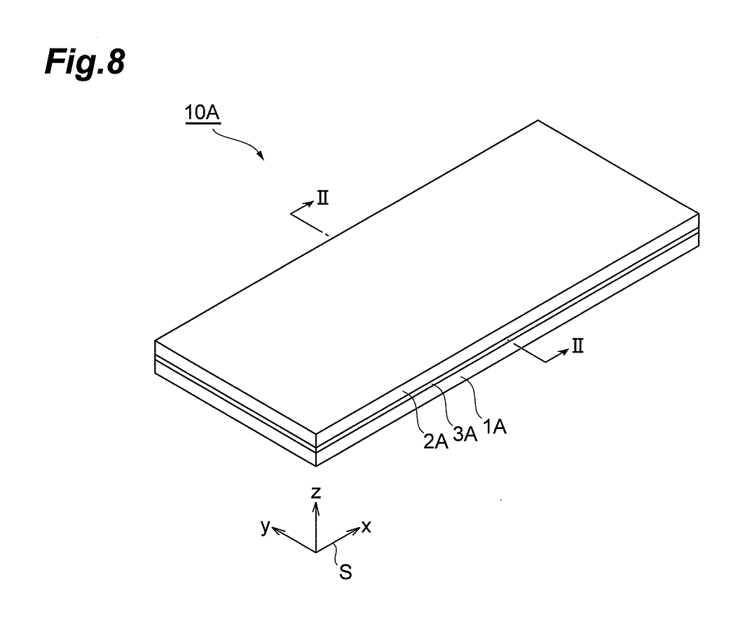

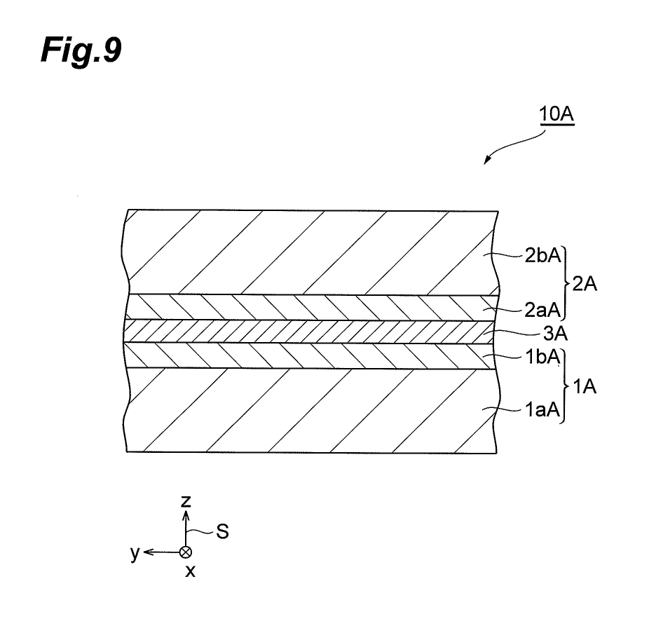

As depicted in FIGS. 8 and 9, a carbon-fiber-reinforced plastic (hereinafter, referred to as “CFRP”) molded object 10A includes a CFRP layer 1A (a first carbon-fiber-reinforced plastic layer) and a CFRP layer 2A (a second carbon-fiber-reinforced layer) that are laminated to each other along the z-axis of the rectangular coordinate system S, and a vibration-damping elastic layer 3A disposed between the CFRP layer 1A and the CFRP layer 2A. This CFRP molded object 10A can be used for industrial parts such as a robot hand, for example.

The CFRP layers 1A and 2A each are in a shape of an elongated plate extending along the x-axis direction of the rectangular coordinate system S, and include a plurality of carbon fiber layers including carbon fibers and a matrix resin (e.g., epoxy resin) with which the carbon fiber layers are impregnated and cured.

The CFRP layer 1A includes an outer layer 1aA and an inner layer 1bA that are laminated in this order along the z-axis direction. The outer layer 1aA can be configured to include, for example, five carbon fiber layers that are disposed in such a manner that the orientation direction of the carbon fibers becomes 0 degree. In addition, the inner layer 1bA can be configured to include, for example, one carbon fiber layer that is disposed in such a manner that the orientation direction of the carbon fibers becomes 90 degrees. Note that the angles herein mean angles with respect to the x-axis direction.

The CFRP layer 2A includes an inner layer 2aA and an outer layer 2bA that are laminated in this order along the z-axis direction. The inner layer 2aA can be configured to include, for example, one carbon fiber layer that is disposed in such a manner that the orientation direction of the carbon fibers becomes 90 degrees. In addition, the outer layer 2bA can be configured to include, for example, five carbon fiber layers that are disposed in such a manner that the orientation direction of the carbon fibers becomes 0 degree.

The vibration-damping elastic layer 3A includes a material containing a viscoelastic resin and a fibrous substance kneaded with the viscoelastic resin. The viscoelastic resin can be a resin that has lower rigidity than that of a matrix resin constituting the CFRP layers 1A and 2A and is made of a viscoelastic material (flexible resin material) such as a rubber and an elastomer. The storage elastic modulus at 25° C. of the viscoelastic material is preferred to be within a range of 0.1 MPa or more and 2500 MPa or less, further preferred to be within a range of 0.1 MPa or more and 250 MPa or less, and still further preferred to be within a range of 0.1 MPa or more and 25 MPa or less. When the storage elastic modulus of the viscoelastic material is equal to or lower than 2500 MPa, sufficient vibration-damping properties can be obtained and, when it is equal to or higher than 0.1 MPa, decrease in rigidity of the CFRP molded object 10A is small, and thus performance required for industrial parts such as a robot hand or a robot arm can be achieved. In addition, because transformation from a carbon fiber prepreg to the CFRP is performed by heat curing, the viscoelastic material is preferred to be stable against the heat generated during the heat curing. Furthermore, the viscoelastic material is preferred to be a material that is excellent in an adhesive property to the matrix resin of the CFRP layers 1A and 2A. In view of the foregoing, the viscoelastic material constituting viscoelastic resin regions 3aA and 3bA can be a material that is more flexible than the CFRP, examples of which include a rubber such as styrene-butadiene rubber (SBR), chloroprene rubber (CR), isobutylene-isoprene rubber (IIR), nitrile-butadiene rubber (NBR), and ethylene-propylene rubber (EPM, EPDM), a polyester resin, a vinylester resin, a polyurethane resin, and an epoxy resin whose elastic modulus is reduced by adding a rubber, an elastomer, or the like that is a polymer having a flexible chain.

The fibrous substance can be one that has higher rigidity than that of this viscoelastic resin and is at least one out of carbon nanotube, Ketjenblack, short glass fiber, and short carbon fiber. The carbon nanotube can be one that has a Young's modulus in the longitudinal direction of fibers thereof within a range of 500 GPa or more and 10000 GPa or less, for example. The short glass fiber can be one that has a Young's modulus in the longitudinal direction of fibers thereof within a range of 60 GPa or more and 90 GPa or less, for example. The short carbon fiber can be one that has a Young's modulus in the longitudinal direction of fibers thereof within a range of 50 GPa or more and 1000 GPa or less, for example.

The length of each of these fibrous substances can be within a range of 1 μm or more and 6 mm or less. When the length of the fibrous substance is equal to or longer than 1 μm, shear force that the fibrous substance exerts on the viscoelastic resin becomes relatively larger, which improves the rigidity of the CFRP molded object 10A and, when it is equal to or shorter than 6 mm, the storage elastic modulus of the vibration-damping elastic layer 3A does not become excessively high, and thus sufficient vibration-damping properties can be obtained. In addition, the aspect ratio of the length of the fibrous substance divided by the diameter of the fibrous substance is preferred to be within a range of 5 or more and 600 or less, and further preferred to be within a range of 5 or more and 300 or less. When the aspect ratio is equal to or higher than 5, entanglement between fibrous substances becomes more likely to occur, and accordingly the rigidity of the CFRP molded object 10A can be improved and, when it is equal to or lower than 600, the fibrous substance can be dispersed in a comparatively uniform manner in kneading the fibrous substance with the viscoelastic resin.

In addition, the mixing ratio of the fibrous substance to the viscoelastic resin can be set within a range of 0.1 wt % or more and 30 wt % or less. When the mixing ratio of the fibrous substance to the viscoelastic resin is equal to or higher than 0.1 wt %, the effect on rigidity improvement of the CFRP molded object 10A is relatively large and, when it is equal to or lower than 30 wt %, sufficient vibration-damping properties can be obtained.

This vibration-damping elastic layer 3A is manufactured, for example, by after adding the fibrous substance to a solution of the viscoelastic resin and stirring them, pouring this mixture into a sheet-shaped mold and drying it, and heating and pressing the resulting mixture by a hot-pressing apparatus.

In addition, the CFRP molded object 10A is manufactured, for example, by disposing the vibration-damping elastic layer 3A manufactured as described above between a prepreg laminate for the CFRP layer 1A and a prepreg laminate for the CFRP layer 2A, and heating and pressing them to integrally form the CFRP layer 1A, the vibration-damping elastic layer 3A, and the CFRP layer 2A.

As described above, in the CFRP molded object 10A, between the CFRP layer 1A and the CFRP layer 2A, the vibration-damping elastic layer 3A including a material containing the viscoelastic resin and the fibrous substance that is kneaded with the viscoelastic resin and has relatively higher rigidity is disposed, which makes it possible to improve flexural rigidity while maintaining vibration-damping properties.

In addition, by using as the fibrous substance at least one out of carbon nanotube, Ketjenblack, short glass fiber, and short carbon fiber, flexural rigidity can be preferably improved.

### Fourth Embodiment

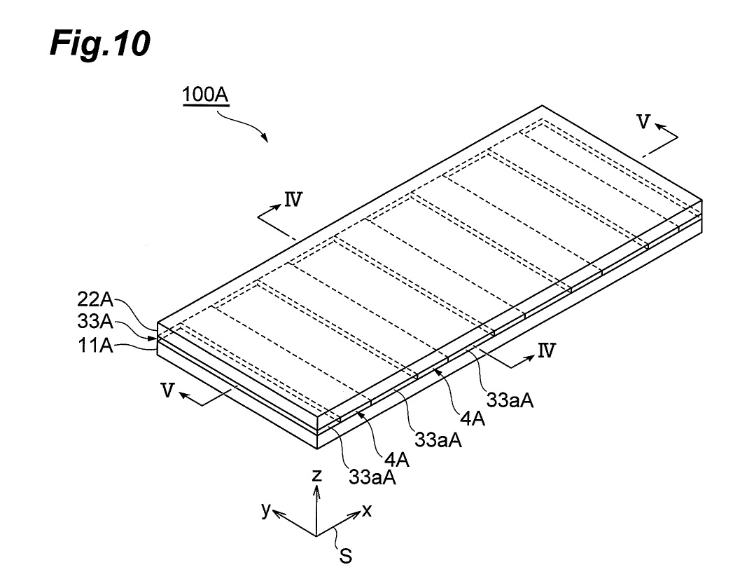

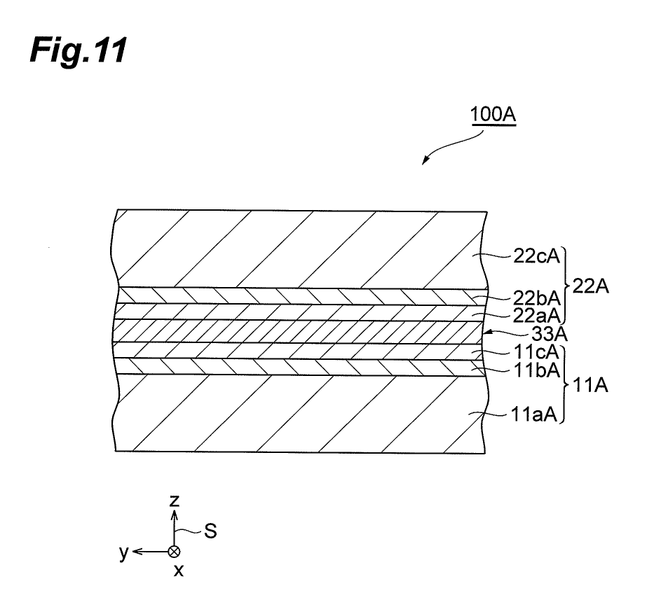

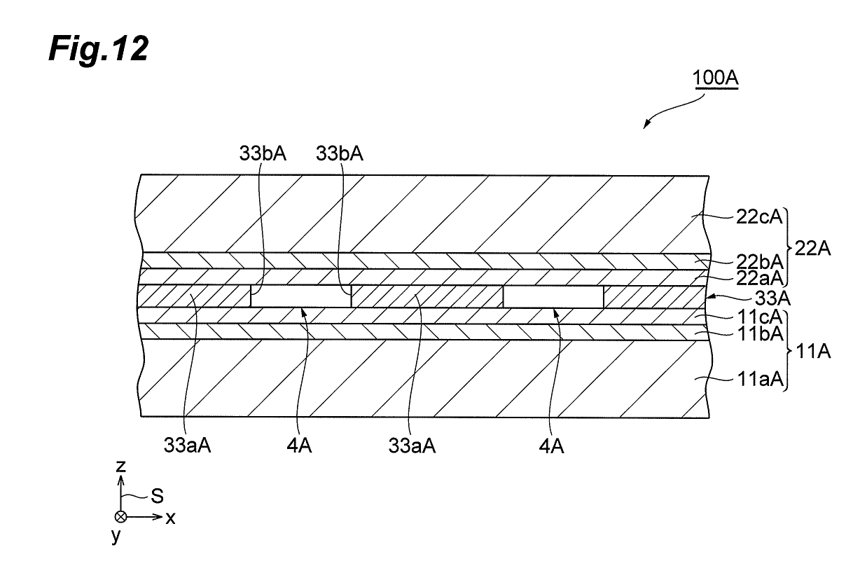

As depicted in FIGS. 10 to 12, the CFRP molded object 100A includes a CFRP layer 11A (a first carbon-fiber-reinforced plastic layer) and a CFRP layer 22A (a carbon-fiber-reinforced plastic layer) that are laminated to each other along the z-axis direction, and a vibration-damping elastic layer 33A disposed between the CFRP layer 11A and CFRP layer 22A.

The CFRP layers 11A and 22A each are in a shape of an elongated plate extending along the x-axis direction, and include a plurality of carbon fiber layers including carbon fibers and a matrix resin (e.g., an epoxy resin) with which the carbon fiber layers are impregnated and cured.

The CFRP layer 11A includes an outer layer 11aA, an intermediate layer 11bA, and an inner layer 11cA that are laminated in this order along the z-axis direction. The outer layer 11aA can be configured to include, for example, four carbon fiber layers that are disposed in such a manner that the orientation direction of the carbon fibers becomes 0 degree. In addition, the intermediate layer 11bA can be configured to include, for example, one carbon fiber layer that is disposed in such a manner that the orientation direction of the carbon fiber thereof becomes 90 degrees. Furthermore, the inner layer 11cA can be configured to include, for example, one carbon fiber layer that is disposed in such a manner that the orientation direction of the carbon fibers becomes 0 degree. Note that the angles herein mean angles with respect to the x-axis direction.

The CFRP layer 22A includes an inner layer 22aA, an intermediate layer 22bA, and an outer layer 22cA that are laminated in this order along the z-axis direction. The inner layer 22aA can be configured to include, for example, one carbon fiber layer that is disposed in such a manner that the orientation direction of the carbon fibers becomes 0 degree. In addition, the intermediate layer 22bA can be configured to include, for example, one carbon fiber layer that is disposed in such a manner that the orientation direction of the carbon fiber thereof becomes 90 degrees. Furthermore, the outer layer 22cA can be configured to include, for example, four carbon fiber layers that are disposed in such a manner that the orientation direction of the carbon fibers becomes 0 degree.

The vibration-damping elastic layer 33A is divided by a plurality of (herein, five) gaps 4A arranged along a longitudinal direction (x-axis direction) of the CFRP layers 11A and 22A into a plurality of (herein, six) regions 33aA. Each of the regions 33aA (i.e., vibration-damping elastic layer 33A) of the vibration-damping elastic layer 33A includes a material containing a viscoelastic resin and a fibrous substance kneaded with the viscoelastic resin. The viscoelastic resin and the fibrous substance can be ones similar to those of the third embodiment. Note that between the adjacent regions 33aA of the vibration-damping elastic layer 33A, opposing surfaces 33bA with the gap 4A interposed therebetween extend along the y-axis direction of the rectangular system S, and also are approximately parallel to each other.

This vibration-damping elastic layer 33A is manufactured, for example, by manufacturing the vibration-damping elastic layer 3A according to the third embodiment, and then dividing it into the regions 33aA.

In addition, the CFRP molded object 100A is manufactured, for example, by disposing the vibration-damping elastic layer 33A manufactured as described above between a prepreg laminate for the CFRP layer 11A and a prepreg laminate for the CFRP layer 22A, and heating and compressing them to integrally form the CFRP layer 11A, the vibration-damping elastic layer 33A, and the CFRP layer 22A.

As described above, also in the CFRP molded object 100A, between the CFRP layer 11A and the CFRP layer 22A, the vibration-damping elastic layer 33A including a material containing the viscoelastic resin and the fibrous substance that is kneaded with the viscoelastic resin and has relatively higher rigidity is disposed, which makes it possible to improve flexural rigidity while maintaining vibration-damping properties.

In addition, in the CFRP molded object 100A, the vibration-damping elastic layer 33A is divided into the regions 33aA by the gaps 4A arranged in the x-axis direction. Accordingly, the regions 33aA of the vibration-damping elastic layer 33A are arranged separately from each other along the x-axis direction, whereby flexural rigidity in the x-axis direction is improved. Furthermore, the opposing surfaces 33bA with the gap 4A interposed therebetween are approximately parallel to each other, and accordingly distributions of vibration-damping properties and flexural rigidity become approximately uniform along the extending direction (y-axis direction) of the surfaces 33bA.

Note that in the CFRP molded object 100A, a high-rigidity resin region including a high-rigidity resin that has higher rigidity than that of the viscoelastic resin can be provided in each of the gaps 4A. In this case, it is possible to further improve flexural rigidity in the x-axis direction. In addition, it is acceptable that this high-rigidity resin be the same as the resin constituting the CFRP layers 11A and 22A, and the high-rigidity resin region be formed integrally with the CFRP layers 11A and 22A. In this case, when integrally forming the CFRP layer 11A, the vibration-damping elastic layer 33A, and the CFRP layer 22A, it is possible to easily form the high-rigidity resin region with the matrix resin constituting the CFRP layers 11A and 22A.

### Example 2

(Specimens) As examples of the CFRP molded object according to the present invention, a specimen AA1 corresponding to the CFRP molded object 10A and a specimen AA2 corresponding to the CFRP molded object 100A were prepared as follows.

(1-1) Specimen AA1

A first prepreg laminate was obtained by laminating five layers of GRANOC prepreg (GRANOC XN-60 (tensile modulus: 620 GPa, carbon fiber areal weight: 125 g/m², matrix resin content: 32 wt %, thickness per layer: 0.11 mm) manufactured by Nippon Graphite Fiber Corporation, the same applies to the following) in such a manner that the orientation direction of the carbon fibers became 0 degree, and laminating thereon one layer of GRANOC prepreg in such a manner that the orientation direction of the carbon fibers became 90 degrees. In addition, a second prepreg laminate was obtained by disposing one layer of GRANOC prepreg in such a manner that the orientation direction of the carbon fibers became 90 degrees, and laminating thereon five layers of GRANOC prepreg in such a manner that the orientation direction of the carbon fibers became 0 degree. Meanwhile, the vibration-damping elastic layer 3A having a thickness of 0.1 mm was obtained by adding the carbon nanotube into a solution of polyurethane resin (Diary (MS4510) manufactured by Diaplex Co., Ltd., the same applies to the following) and stirring them, pouring this mixture into a sheet-shaped mold to dry it, and heating and pressing the resulting mixture at 150° C. for one hour by a hot-pressing apparatus. At this time, the mixing ratio of the carbon nanotube to the polyurethane resin was 5 wt %. Then, the specimen AA1 including the CFRP layer 1A, the vibration-damping elastic layer 3A, and the CFRP layer 2A was obtained by laminating the first prepreg laminate, the vibration-damping elastic layer 3A, and the second prepreg laminate in this order, and heating and pressing them at 130° C. for one and a half hours.

(1-2) Specimen AA2

A third prepreg laminate was obtained by laminating four layers of GRANOC prepreg in such a manner that the orientation direction of the carbon fibers became 0 degree, laminating thereon one layer of GRANOC prepreg in such a manner that the orientation direction of the carbon fibers became 90 degrees, and further laminating thereon one layer of GRANOC prepreg in such a manner that the orientation direction of the carbon fibers became 0 degree. In addition, a fourth prepreg laminate was obtained by disposing one layer of GRANOC prepreg in such a manner that the orientation direction of the carbon fibers became 0 degree, laminating thereon one layer of GRANOC prepreg in such a manner that the orientation direction of the carbon fibers became 90 degrees, and further laminating thereon four layers of GRANOC prepreg in such a manner that the orientation direction of the carbon fibers became 0 degree. Meanwhile, the vibration-damping elastic layer having a thickness of 0.1 mm was obtained by adding the short glass fiber into a solution of the polyurethane resin and stirring them, pouring this mixture into the sheet-shaped mold to dry it, and heating and pressing the resulting mixture at 150° C. for one hour by the hot-pressing apparatus. At this time, the mixing ratio of the short glass fiber to the polyurethane resin was 5 wt %. Also, the length of the short glass fiber was 3 mm. Furthermore, the vibration-damping elastic layer thus obtained was divided into six regions to obtain the vibration-damping elastic layer 33A. The width of each of the gaps 4A between the regions 33aA into which the vibration-damping elastic layer 33A was divided was 2 mm. Then, the specimen AA2 including the CFRP layer 11A, the vibration-damping elastic layer 33A, and the CFRP layer 22A was obtained by laminating the third prepreg laminate, the vibration-damping elastic layer 33A, and the fourth prepreg laminate in this order, and heating and pressing them at 130° C. for one and a half hours.

### (2) Comparative Examples

As comparative examples for the specimens AA1 and AA2, a comparative specimen BA described below was prepared. The comparative specimen BA includes, in place of the vibration-damping elastic layer 3A, a vibration-damping elastic layer that has a thickness of 0.1 mm and includes the polyurethane resin alone. The other configuration of the comparative specimen BA is similar to that of the specimen AA1.

All of the specimen AA1, the specimen AA2, and the comparative specimen BA described above have a length of 45 mm, a width of 5 mm, a thickness of about 1.4 mm or more and 1.5 mm or less.

### (3) Measurement

By using a dynamics mechanical analysis (DMA) measurement apparatus (ITK-DVA225) manufactured by IT Measurement Control Co., Ltd., in a three-point bending vibration mode along the longitudinal direction, the storage elastic modulus (elastic component)=E′, the loss storage elastic modulus (viscous component)=E″, and the loss tangent=E″/E′=tan δ for each of the specimen AA1, the specimen AA2, and the comparative specimen BA were measured. Herein, the three-point bending vibration mode is a measuring method for measuring viscoelastic behavior by applying vibration to the center portion with both end portions clamped in the longitudinal direction for each specimen.

### (4) Measurement Results

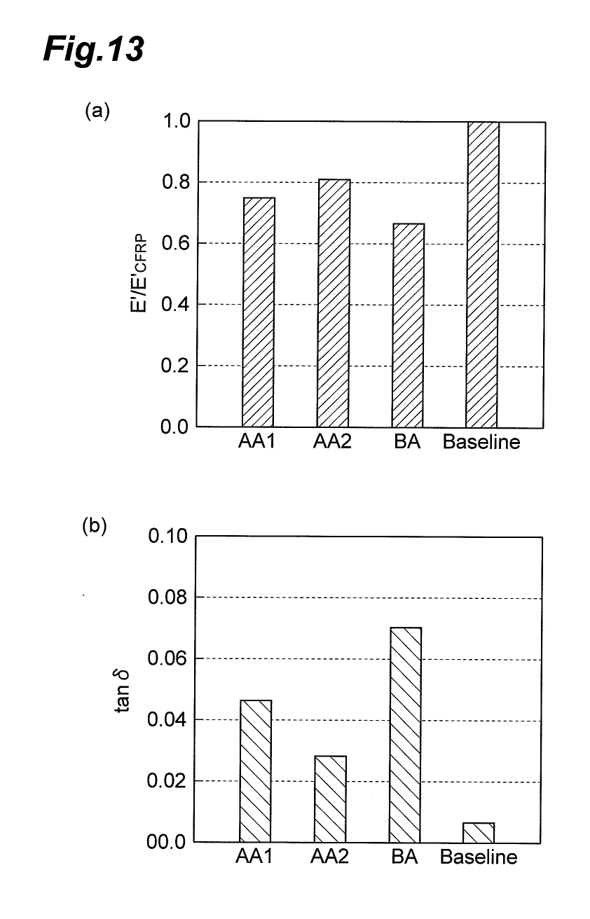

The Measurement results are illustrated in FIG. 13. FIG. 13(a) depicts the flexural elastic modulus retention ratio (E′/E′_{CFRP}) of each specimen at 25° C. Herein, E′_{CFRP} is a storage elastic modulus of a CFRP molded object that does not have a vibration-damping elastic layer (including only the CFRP layer 1A and the CFRP layer 2A). FIG. 13(b) depicts tan δ of each specimen at 25° C. In FIGS. 13(a) and 13(b), AA1 represents a measurement value of the specimen AA1, AA2 represents a measurement value of the specimen AA2, and BA represents a measurement value of the comparative specimen BA. Note that in these drawings, Baseline represents a measurement value of the CFRP molded object that does not have a vibration-damping elastic layer. Herein, the flexural elastic modulus retention ratio (E′/E′_{CFRP}) is a value as an index of flexural rigidity, and as this value becomes larger, the flexural rigidity becomes higher. The tan δ is a value as an index of vibration-damping properties, and as this value becomes larger, the vibration-damping properties become higher.

As depicted in FIG. 13(a), E′/E′_{CFRP} of the specimen AA1 was 0.75, and E′/E′_{CFRP} of the specimen AA2 was 0.81. In contrast, E′/E′_{CFRP} of the comparative specimen BA was 0.67. From these, it was found that the flexural rigidity could be improved in the specimen AA1 compared to the comparative specimen BA. In addition, it was found that the flexural rigidity in the longitudinal direction could be further improved in the specimen AA2.

In addition, as depicted in FIG. 13(b), tan δ of each of the specimens AA1 and AA2 was sufficiently larger than tan δ of the CFRP molded object that did not have a vibration-damping elastic layer. From this, it was found that sufficient vibration-damping properties could be secured in the specimen AA1 and the specimen AA2 compared to the CFRP molded object that did not have a vibration-damping elastic layer.

### INDUSTRIAL APPLICABILITY

According to the present invention, it becomes possible to provide a carbon-fiber-reinforced plastic molded object making it possible to improve vibration-damping properties while maintaining flexural rigidity, and the carbon-fiber-reinforced plastic molded object making it possible to improve flexural rigidity while maintaining vibration-damping properties.

### REFERENCE SIGNS LIST

10, 100 . . .CFRP molded object, 1, 2, 11, 22 . . . CFRP layer, 3 . . . vibration-damping elastic layer, 3a, 3b . . . viscoelastic resin region, 3c, 3d . . . surface, 4 . . . high-rigidity resin region, 10A, 100A . . . CFRP molded object, 1A, 2A, 11A, 22A . . .CFRP layer, 3A, 33A . . . vibration-damping elastic layer, 33aA . . . regions, 33bA . . . surfaces, 4A . . . gaps

1. A carbon-fiber-reinforced plastic molded object comprising:
first and second carbon-fiber-reinforced plastic layers in an elongated shape and laminated to each other; and
a vibration-damping elastic layer disposed between the first carbon-fiber-reinforced plastic layer and the second carbon-fiber-reinforced plastic layer, wherein
the vibration-damping elastic layer includes a plurality of viscoelastic resin regions including a viscoelastic resin,
the viscoelastic resin regions are arranged separately from each other along a longitudinal direction of the first and the second carbon-fiber-reinforced plastic layers, and
a high-rigidity resin region including a high-rigidity resin that has higher rigidity than that of the viscoelastic resin is provided between the viscoelastic resin regions adjacent to each other.

2. The carbon-fiber-reinforced plastic molded object according to claim 1, wherein opposing surfaces with the high-rigidity resin region interposed therebetween in the adjacent viscoelastic resin regions are approximately parallel to each other.

3. The carbon-fiber-reinforced plastic molded object according to claim 1, wherein
the high-rigidity resin is the same as a resin constituting the first and the second carbon-fiber-reinforced plastic layers, and
the high-rigidity resin region is formed integrally with the first and the second carbon-fiber-reinforced plastic layers.

4. A carbon-fiber-reinforced plastic molded object comprising:
first and second carbon-fiber-reinforced plastic layers laminated to each other; and
a vibration-damping elastic layer disposed between the first carbon-fiber-reinforced plastic layer and the second carbon-fiber-reinforced plastic layer, wherein
the vibration-damping elastic layer includes a material containing a viscoelastic resin and a fibrous substance dispersed in the viscoelastic resin, and
the fibrous substance has higher rigidity than that of the viscoelastic resin.

5. The carbon-fiber-reinforced plastic molded object according to claim 4, wherein
the first and the second carbon-fiber-reinforced plastic layers are in an elongated shape, and
the vibration-damping elastic layer is divided into a plurality of regions by a plurality of gaps arranged along a longitudinal direction of the first and the second carbon-fiber-reinforced plastic layers.

6. The carbon-fiber-reinforced plastic molded object according to claim 5, wherein opposing surfaces with the gap interposed therebetween are approximately parallel to each other in the adjacent regions.

7. The carbon-fiber-reinforced plastic molded object according to claim 4, wherein the fibrous substance is at least one out of carbon nanotube, Ketjenblack, short glass fiber, and short carbon fiber.
